(19) United States
(12) Patent Application Publication
(10) Pub. No.: US 2025/0238206 A1
(43) Pub. Date: Jul. 24, 2025

(54) RETRIEVAL-AUGMENTED DIGITAL WORKFLOW GENERATION

(71) Applicant: ServiceNow, Inc., Santa Clara, CA (US)

(72) Inventors: Patrice Bechard, Montreal (CA); Orlando Marquez, Montreal (CA); Luke Kumar, Vaughan (CA); Juell Chase Solaegui, San Diego, CA (US); Milap Dhirenkumar Shah, Tracy, CA (US)

(21) Appl. No.: 18/615,741

(22) Filed: Mar. 25, 2024

Related U.S. Application Data
(60) Provisional application No. 63/623,659, filed on Jan. 22, 2024.

(51) Int. Cl. G06F 8/30; G06F 8/10

(52) U.S. Cl. CPC G06F 8/30; G06F 8/10

(57) ABSTRACT

A description of a desired computer workflow is obtained. Based on the description of the desired computer workflow, a set of prospective components from a plurality of components is selected. A prompt is generated using the description of the desired computer workflow and the set of prospective components. Based on providing the prompt to a large-language-model, at least a portion of code associated with the desired computer workflow is generated.

### CROSS REFERENCE TO OTHER APPLICATIONS

This application claims priority to U.S. Provisional Patent Application No. 63/623,659 entitled REDUCING HALLUCINATION IN STRUCTURED OUTPUTS VIA RETRIEVAL AUGMENTED GENERATION filed Jan. 22, 2024 which is incorporated herein by reference for all purposes.

### BACKGROUND OF THE INVENTION

Digital workflow tools enable non-programmers to create functional workflows with little to no programming knowledge. The created workflows automate complex manual tasks and can implement business related functionalities, such as actions related to HR procedures, IT ticketing, and integrations with third-party services. Although the workflow tools include user interfaces that are low-code and codeless, the tools typically require specialized knowledge related to workflow programming paradigms and execution paths. This required knowledge is a significant barrier to entry for creating workflows. Therefore, there exists a need for a low-code or codeless workflow tool that allows novice users to create a digital workflow by describing the desired workflow's execution in a natural language.

### BRIEF DESCRIPTION OF THE DRA WINGS

Various embodiments of the invention are disclosed in the following detailed description and the accompanying drawings.

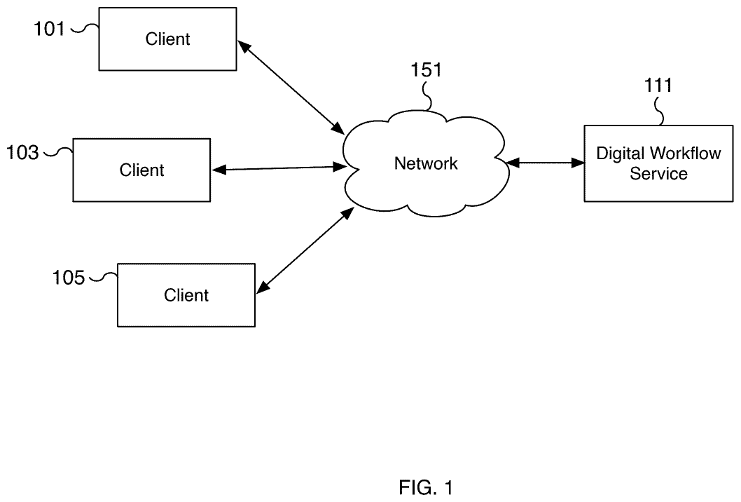

FIG. 1 is a block diagram illustrating an embodiment of a digital workflow service platform that includes the ability to create a digital workflow from a natural language description.

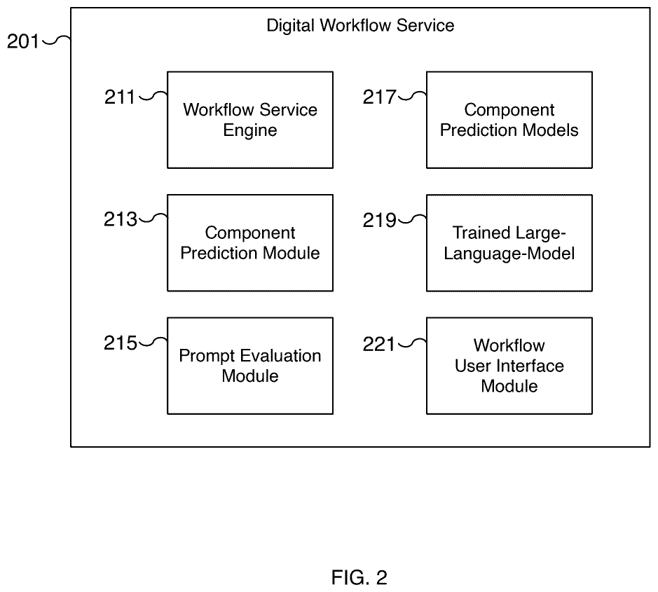

FIG. 2 is a block diagram illustrating an embodiment of a digital workflow service for generating and executing digital workflows.

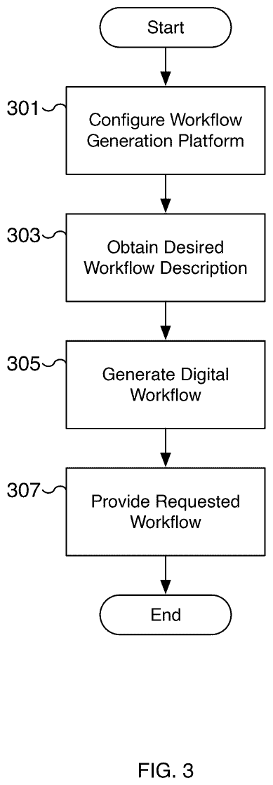

FIG. 3 is a flow chart illustrating an embodiment of a process for automatically generating a digital workflow from a received workflow description.

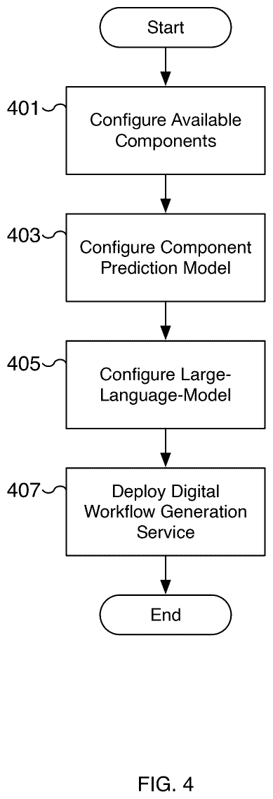

FIG. 4 is a flow chart illustrating an embodiment of a process for configuring a digital workflow generation service.

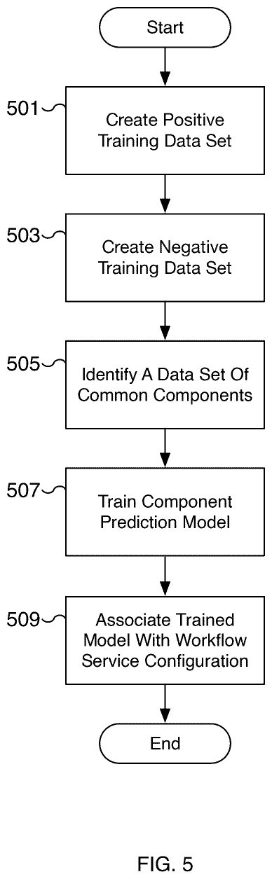

FIG. 5 is a flow chart illustrating an embodiment of a process for configuring a component prediction model.

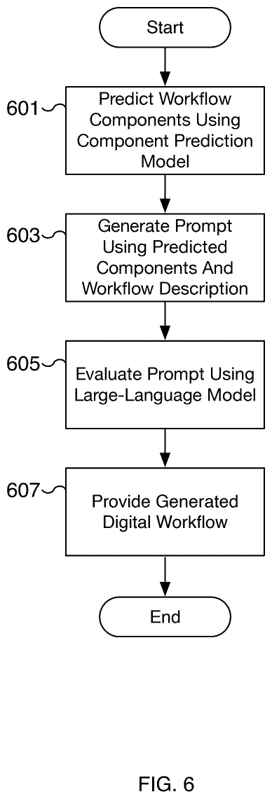

FIG. 6 is a flow chart illustrating an embodiment of a process for automatically generating, using a retrieval-augmented technique, a digital workflow from a received workflow description.

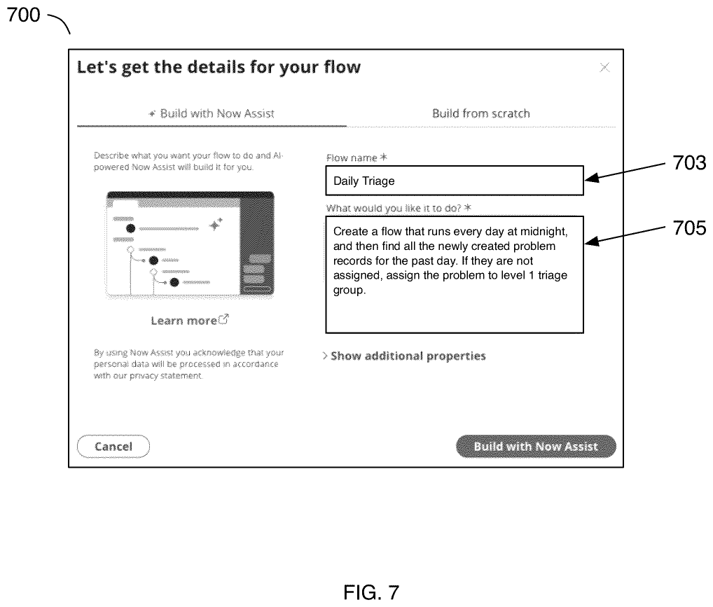

FIG. 7 is a diagram illustrating an embodiment of a user interface for creating a digital workflow from a natural language description.

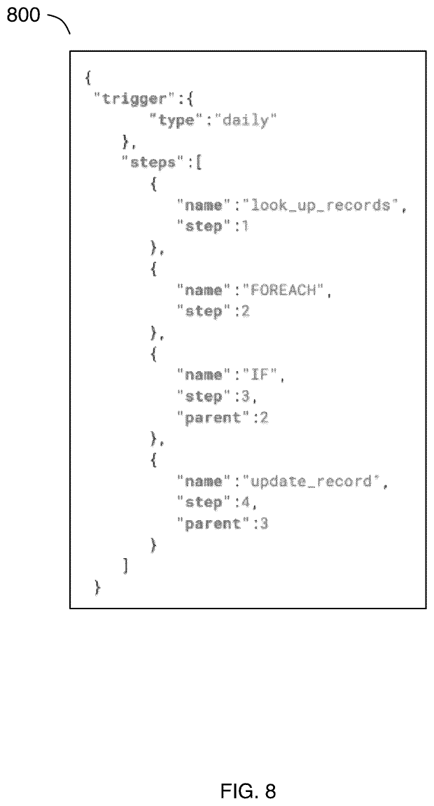

FIG. 8 is a diagram illustrating an embodiment of a digital workflow generated from a natural language description.

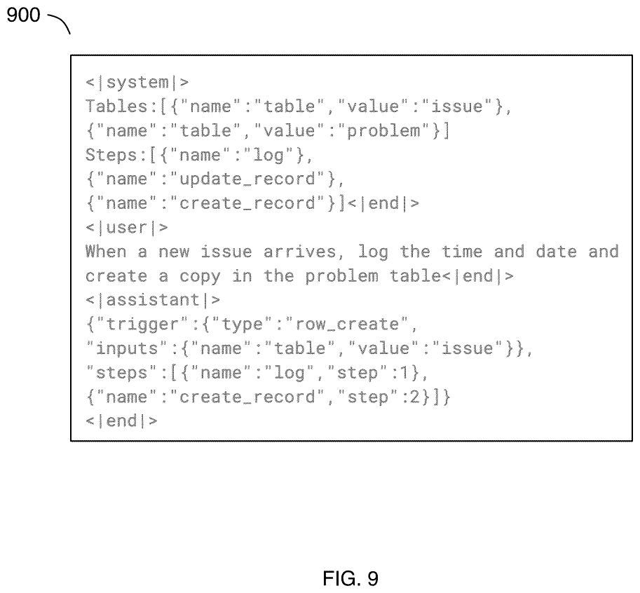

FIG. 9 is a diagram illustrating an embodiment of a training data example used to train a large-language-model to generate a digital workflow from a natural language description.

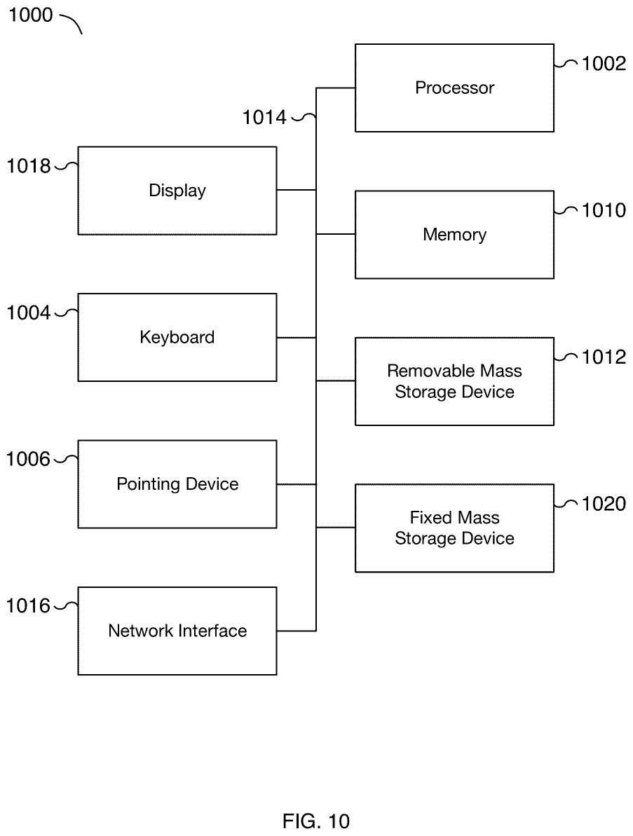

FIG. 10 is a functional diagram illustrating a programmed computer system for creating a digital workflow from a natural language description.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Retrieval-augmented digital workflow generation is disclosed. For example, using the disclosed techniques and/or systems, a structured digital workflow can be generated using natural language as input. The natural language description is received and used to generate a set of likely or prospective components that would be utilized to implement the corresponding digital workflow. In various embodiments, the set of likely components is generated using a neural retriever. For example, the neural retriever can be trained using the set of available and verified components. As a result, the output from the neutral retriever is highly accurate and minimizes the introduction of unavailable and non-existent components. In various embodiments, the natural language description and the retrieved components are provided to a generative artificial intelligence (AI) model such as a large-language-model via a generative AI prompt to request a digital workflow described by the natural language description. The digital workflow generated by the generative AI model is based on the retrieval-augmented components. By biasing the generative AI model using the retrieval-augmented components, the generation of an accurate digital workflow is significantly increased. For example, the likelihood a workflow is generated that relies on non-existent components is minimized. Moreover, the disclosed retrieval-augmented digital workflow generation utilizing a neural retriever to feed a generative AI model is significantly less resource intensive than relying solely on a generative AI model.

The disclosed retrieval-augmented digital workflow generation platform and techniques enable non-programmers to create functional workflows with little to no programming knowledge. The created workflows automate complex manual tasks and can implement various processes and associated functionalities. Although existing workflow tools can include user interfaces that are low-code and codeless, the traditional tools typically require specialized knowledge related to workflow programming paradigms and execution paths. This required knowledge is a significant barrier to entry for creating workflows. Therefore, there exists a need for a low-code or codeless workflow tool that allows novice users to create a digital workflow by describing the desired workflow's execution in a natural language.

Although certain digital workflows can be generated from natural language input using a machine learning model, existing large-language-models are highly prone to hallucinations and generating the desired digital workflow using a large-language-model is expensive. Consequently, a digital workflow generated with a large-language-model requires a significant allocation of resources (memory, processor, power, etc.) and yet often includes components, such as certain actions or steps of the generated workflow, that are non-existent. Although providing the appearance of meeting the desired workflow requirements, a workflow with invalid components is invalid and non-functioning. Using the disclosed digital workflow generation techniques and, in particular by augmenting the input to a large-language-model with predicted retrieval-augmented components, technical challenges related to performance and accuracy requirements are addressed.

In some embodiments, a description of a desired computer workflow is obtained. For example, a description of a desired workflow is received. The description can be provided in an unstructured format such as a natural language description. In some embodiments, based on the description of the desired computer workflow, a set of prospective components from a plurality of components is selected. For example, a set of components likely to be included in an implementation of the desired workflow is selected. The selected prospective components can be predicted using a component prediction model. In some embodiments, a prompt using the description of the desired computer workflow and the set of prospective components is generated. For example, a generative artificial intelligence (AI) prompt is created using the selected prospective components and the obtained description of a desired computer workflow. The prompt can be created using a prompt template and is used to request the generation of a digital workflow of the desired workflow. In some embodiments, based on providing the prompt to a large-language-model, at least a portion of code associated with the desired computer workflow is generated. For example, a code representation of the digital workflow that implements the described desired workflow is generated using a large-language-model. The output of the large-language-model can be a structured representation of the digital workflow, such as a representation of the digital workflow in structured object- or node-based format. Using the result of the large-language-model, the desired computer workflow can be automatically coded. For example, an executable version of the digital workflow can be created based on the generated code representation of the digital workflow.

In various embodiments, the obtained description of the desired computer workflow enables non-programmers to create functional workflows with little to no programming knowledge including little knowledge of existing programming paradigms and workflow execution terminology that are required by even graphical workflow tools. Instead, for example, a user can provide a description of the desired computer workflow in a natural language format. By selecting a set of prospective components from a plurality of components based on the description of the desired computer workflow, the disclosed techniques ground the requested digital workflow using only existing and valid components. This step significantly improves the accuracy of the generated digital workflow by minimizing hallucinations. Furthermore, by using a neural retriever to predict the set of prospective components, significantly fewer resources are required at both training and inference time than compared to an even less accurate (and invalid) result generated by a large-language-model. Moreover, by generating a prompt using the description of the desired computer workflow and the set of prospective components, the disclosed techniques can utilize a trained large-language-model with highly accurate results. The generated prompt limits the scope and requirements demanded of a large-language-model by seeding the large-language-model with retrieval augmented results. Based on providing the generated prompt to a large-language-model, at least a portion of code associated with the desired computer workflow is generated. As a result, the large-language-model can be utilized to generate a highly accurate digital workflow with minimal hallucinations and/or invalid components. Using the generated prompt and retrieval-augmented results allows the disclosed inventions to reduce the cost requirements associated with the inference step performed by the large-language-model. The overall result is a significant improvement in at least performance, efficiency, and cost when generating a digital workflow from a description of a desired computer workflow.

In some embodiments, a description of a desired computer workflow is received. For example, a natural language description of a computer workflow is provided by a user. The description can describe the intended workflow, such as its actions and/or results, without necessarily using technical language such as programming constructs. In some embodiments, the description is received in an audio or another format and then converted to a text-based format. For example, using natural language processing a received audio description is converted to a text-based description of the desired computer workflow. In some embodiments, components of the computer workflow are predicted based on at least a portion of the description of the desired computer workflow provided to a component prediction model. For example, a component prediction model is used to predict the components that are likely to be used in the desired computer workflow. The component prediction model receives as input at least a version of the desired computer workflow description and outputs a list of predicted components for the desired workflow. In various embodiments, the list of predicted components is restricted to components that are available and validated for use and does not include hallucinated component results. Using the list of predicted components and the description of a desired computer workflow, a digital workflow can be automatically generated.

In some embodiments, a prompt automatically generated using the description of the desired computer workflow and the predicted components of the computer workflow indicated by the component prediction model is provided to a large-language-model. For example, a generative artificial intelligence (AI) prompt is automatically created using the list of predicted components and the description of a desired computer workflow. In some embodiments, the prompt is created using a prompt template that allows for the inclusion of necessary prompt information. By biasing the large-language-model using available and validated components from the list of predicted components, the results from the large-language-model are highly accurate and hallucinations are significantly minimized. In some embodiments, a result of the large-language-model is used to automatically code the desired computer workflow. For example, the results of the large-language-model is a structured representation of the desired computer workflow and can be used to implement the desired computer workflow. In some embodiments, the results of the large-language-model are converted to a visual representation of the desired computer workflow that is provided to users via a workflow dashboard and/or workflow user interface. In some embodiments, users can further modify the created workflow including by adding inputs to customize the digital workflow. In various embodiments, the created workflow can be executed as a workflow service.

FIG. 1 is a block diagram illustrating an embodiment of a digital workflow service platform that includes the ability to create a digital workflow from a natural language description. In the example shown, clients 101, 103, and 105 are network clients configured to create and/or access digital workflows created and hosted by digital workflow service 111. Clients 101, 103, and 105 are communicatively connected to digital workflow service 111 via network 151. Network 151 can be a public or private network. In some embodiments, network 151 is a public network such as the Internet. Digital workflow service 111 provides cloud-based workflow related services including the ability to create and host digital workflows. For example, using digital workflow service 111 via a client such as one of clients 101, 103, or 105, a user can provide a natural language description of a desired workflow. The corresponding digital workflow is created by digital workflow service 111 and can be hosted and executed by digital workflow service 111 as a workflow service. In some embodiments, the created workflow can be visualized and further managed, such as modified and/or enhanced, via a workflow graphical user interface (GUI) provided by digital workflow service 111. For example, a workflow dashboard can be provided by digital workflow service 111 to visually interact with a digital workflow.

In some embodiments, clients 101, 103, and 105 are each a network client device for interfacing with digital workflow services hosted by digital workflow service 111. For example, each of clients 101, 103, and 105 can be configured with a browser to access workflow services of digital workflow service 111 including the ability to create a digital workflow from a natural language description. The natural language description can be provided in various formats such as an audio format and/or a written description. In various embodiments, the clients 101, 103, and 105 are further utilized to manage created digital workflows such as to modify the created workflows using a graphical user interface and to manage their operations via a workflow dashboard.

In some embodiments, digital workflow service 111 is a cloud server that offers functionality for creating, hosting, and/or managing digital workflows. Corresponding graphical user interfaces can be provided by digital workflow service 111 to allow users to visually interact with a digital workflow and/or to manage the operation of a workflow. Additionally, digital workflow service 111 provides a service for creating digital workflows from natural language descriptions. For example, the description of a desired workflow can be provided as an audio and/or text-based description and a corresponding digital workflow can be automatically generated. In some embodiments, the corresponding digital workflow is generated using the disclosed retrieval-augmented workflow generation techniques. For example, the workflow can be generated by providing a generative artificial intelligence (AI) prompt grounded with predicted workflow components to a large-language-model. The grounded generative AI prompt can be created using the output from a component prediction module such as one that relies on a neural retriever trained using the set of available and verified components available for creating digital workflows. By biasing the large-language-model using available and validated components, the generated digital workflows from digital workflow service 111 are highly accurate and hallucinations are significantly minimized.

Although single instances of some components have been shown to simplify the diagram of FIG. 1, additional instances of any of the components shown in FIG. 1 may exist. For example, digital workflow service 111 may include one or more cloud servers such as one or more machine learning training, machine learning inference, and/or web application servers and one or more databases utilized by the cloud servers. Additionally, clients 101, 103, and 105 are example client devices for accessing and utilizing the services of digital workflow service 111. Although three clients are shown (clients 101, 103, and 105), many more additional clients can exist and access the services of digital workflow service 111. In some embodiments, components not shown in FIG. 1 may also exist.

FIG. 2 is a block diagram illustrating an embodiment of a digital workflow service for generating and executing digital workflows. In the example shown, digital workflow service 201 is a cloud-based service for creating and hosting digital workflows. Desired workflows can be created by digital workflow service 201 using the disclosed retrieval-augmented workflow generation techniques. Once created, whether automatically generated using digital workflow service 201 or via a more manual technique such as using a low-code and codeless workflow tool, a digital workflow can be hosted and executed by digital workflow service 201. Digital workflow service 201 includes workflow service engine 211, component prediction module 213, prompt evaluation module 215, component prediction models 217, trained large-language-model 219, and workflow user interface module 221. In some embodiments, digital workflow service 201 is digital workflow service 111 of FIG. 1. In some embodiments, the clients accessing and utilizing the services of digital workflow service 201 include clients 101, 103, and/or 105 of FIG. 1.

In some embodiments, digital workflow service 201 includes multiple processing modules for creating and hosting digital workflows. In various embodiments, one or more of the modules shown may not exist and/or additional modules may exist. In some embodiments, the functionality of one or more of the modules may be merged into a single module or split out across multiple different modules. In some embodiments, digital workflow service 201 is implemented by one or more cloud servers and one or more data stores such as one or more databases including distributed databases. In some embodiments, the cloud servers include machine learning training and inference servers as well as web application servers.

In some embodiments, workflow service engine 211 is a functional module for providing digital workflow related services such as the creation of a digital workflow from a provided description and/or the execution of created digital workflows. In some embodiments, workflow service engine 211 utilizes the other components, modules, and models of digital workflow service 201 to implement the provided services. For example, workflow service engine 211 may utilize workflow user interface module 221 to implement user interface features for accessing the functionality provided by workflow service engine 211. In some embodiments, workflow service engine 211 implements the functionality to create digital workflows by utilizing component prediction module 213, prompt evaluation module 215, component prediction models 217, trained large-language-model 219, and workflow user interface module 221. For example, as part of a digital workflow creation process, workflow service engine 211 utilizes the different components to generate a retrieval-augmented digital workflow from a natural language description. In various embodiments, other workflow services provided by workflow service engine 211 can include the ability to monitor and manage a workflow and can be implemented, at least in part, by components and/or modules that are not shown in FIG. 2.

In some embodiments, component prediction module 213 is a processing module to predict at least a subset of the components that are likely to be utilized by a desired digital workflow. For example, component prediction module 213 can utilize one or more models of component prediction models 217 to accurately predict components that can enable a specific digital workflow, such as one described using a natural language description. In some embodiments, component prediction module 213 can select the proper model from component prediction models 217 based on the desired workflow. For example, based on the capabilities accessible for the requesting user, component prediction module 213 can select a component prediction model from component prediction models 217 that is trained for the particular use case. In various embodiments, based at least in part on a natural language description of a desired workflow, component prediction module 213 provides a list of components that are verified and/or accessible for use in implementing the desired workflow. By ensuring the predicted components are verified, the likelihood of hallucinations in the final generated digital workflow is significantly reduced.

In some embodiments, prompt evaluation module 215 is a processing module for creating and evaluating a generative artificial intelligence (AI) prompt using a large-language-model such as the large-language-model of trained large-language-model 219. In some embodiments, the generative AI prompt is created by prompt evaluation module 215 using a prompt template that incorporates at least a portion of a natural language description of a desired workflow and predicted components for the desired workflow determined by component prediction module 213. Prompt evaluation module 215 can initiate the evaluation of the prompt using the appropriate large-language-model to generate a digital workflow. In some embodiments, the digital workflow generated is a structured representation of the digital workflow. For example, the structured representation of the digital workflow can be in a text-based format such as JavaScript Object Notation. In various embodiments, the generated workflow is grounded by and can utilize one or more of the predicted components provided by component prediction module 213.

In some embodiments, component prediction models 217 are a collection of one or more prediction models trained based on available workflow components. For example, different users (or customers) may have access to different components and the different component prediction models of component prediction models 217 are trained to predict only the components available for each different user (or customer). By training the models based on actual available components, the impact of hallucinations on prediction results is minimized. In various embodiments, component prediction models 217 provides the appropriate prediction model based on the access permissions and/or capabilities relevant for the desired workflow. In some embodiments, the actual prediction models may be stored locally and/or remotely. For example, the specific models of component prediction models 217 can be accessed via an application programming interface (API) that does not necessarily require the models to be local to digital workflow service 201.

In some embodiments, trained large-language-model 219 is a pre-trained large-language-model. Trained large-language-model 219 can be trained using significantly large amounts of data and is enabled to process language, including human or natural language, and to provide a result in response to a provided generative artificial intelligence (AI) prompt. In various embodiments, trained large-language-model 219 can generate a digital workflow from a generative AI prompt by biasing the requested workflow with components predicted to be relevant to the desired workflow. In various embodiments, trained large-language-model 219 can be a third-party large-language-model such as a large-language-model trained by a third-party for performing both specific and generic artificial intelligence (AI) tasks. In some embodiments, trained large-language-model 219 is two or more models and the appropriate large-language-model is selected for evaluation based on the desired workflow. For example, different large-language-models can be selected based on the scenario required for the workflow including based on resource requirements, accessibility, and/or cost, among other factors, for evaluating large-language-models. In some embodiments, the appropriate large-language-model is selected based on the type of desired workflow.

In some embodiments, workflow user interface module 221 provides a graphical user interface (GUI) for interfacing with digital workflows. For example, workflow user interface module 221 can provide a web-based or application-based GUI that allows a user to provide a desired workflow description. Once the corresponding digital workflow is generated, workflow user interface module 221 can provide a visual representation of the generated workflow. In some embodiments, the provided GUI allows a user to manage and/or modify the workflow such as by customizing the workflow with specific parameter values and/or data arguments. In some embodiments, workflow user interface module 221 provides a workflow dashboard for monitoring and managing the execution of the created workflow.

FIG. 3 is a flow chart illustrating an embodiment of a process for automatically generating a digital workflow from a received workflow description. For example, using the process of FIG. 3, a digital workflow service platform can automatically create a digital workflow from a natural language description. Rather than requiring a user to create a workflow using strict programming and workflow constructs, the desired workflow is described in audio, text, and/or another format using natural language. In some embodiments, the digital workflow generated is a structured representation of the desired workflow such as a text-based representation using JavaScript Object Notation (JSON) or another appropriate format. The generated workflow can be used to implement an executable version of the workflow as well as to provide a visual representation of the workflow. Using the generated workflow, a user can modify and/or enhance the workflow such as by incorporating custom data parameters or arguments. In some embodiments, the digital workflow service platform used to perform the process of FIG. 3 corresponds to digital workflow service 111 of FIG. 1 and/or digital workflow service 201 of FIG. 2. In some embodiments, the clients used to interface with the digital workflow service are clients 101, 103, and/or 105 of FIG. 1.

At 301, a workflow generation platform is configured. For example, the necessary models including component prediction models and large-language-models are configured. In some embodiments, model configuration includes training a model and/or configuring access permissions for utilizing the model. For example, a component prediction model can be trained for each set of available components. In some scenarios, different users or customers are configured to utilize a different subset of workflow components and a different component prediction model is trained for each different configuration. In some embodiments, a third-party large-language-model is utilized and access permissions including application programming interface access are configured.

At 303, a desired workflow description is obtained. For example, a description provided in a natural language format is received by the digital workflow service platform. The description may be one or more different formats including an audio format, a text format, and/or another appropriate format including mixed medium formats of a desired workflow. In some embodiments, the received description is converted to a text-based format. For example, an audio description can be converted to a text-based or tokenized format. In various embodiments, the received description describes the desired workflow without requiring the user to incorporate highly technical keywords or utilized workflow specific constructs. The ability to provide a natural language description increases the accessibility of workflow creation.

At 305, a digital workflow is generated. For example, using the description received at 303, a digital workflow is generated using retrieval-augmented workflow generation techniques. In various embodiments, components of the desired workflow are first predicted using a component prediction model. The appropriately trained component prediction model is utilized based on the components available to the particular user and/or customer. By selectively choosing a component prediction model based on the components available for the desired workflow, the accuracy of the predicted components is significantly increased and hallucinations are minimized. In various embodiments, using the predicted components and the received natural language description, a generative artificial intelligence (AI) prompt is created. The generative AI prompt is evaluated using a large-language-model to generate the resulting digital workflow. By utilizing a component prediction model to ground the large-language-model with the predicted components, the accuracy of the generated digital workflow is also significantly improved and the overall resources required to create the workflow are significantly reduced.

At 307, the requested workflow is provided. For example, the generated digital workflow is provided in a structured format. The generated digital workflow can be converted to an executable format and hosted as part of a workflow service. For example, using the structured format of the generated workflow, each node of the structured workflow can correspond to a particular step, action, or another workflow building block, etc. In some embodiments, the structured workflow output is used to generate a visual representation of the workflow. For example, a graphical user interface can display a visual representation of the workflow and allow users to manage, enhance, and/or modify the workflow such as by adding or changing data parameters and arguments to the workflow.

FIG. 4 is a flow chart illustrating an embodiment of a process for configuring a digital workflow generation service. For example, using the process of FIG. 4, a digital workflow service platform can be configured for automatically generating a digital workflow from a received and/or obtained natural language description. In some embodiments, the digital workflow generated is a structured representation of the desired workflow such as a text-based representation using JavaScript Object Notation (JSON) or another appropriate format. The digital workflow can be generated using a retrieval-augmented process that first predicts likely components of the desired workflow using a component prediction model and then generates a representation of the desired workflow from the predicted components and the received description using a large-language-model. In some embodiments, the process of FIG. 4 is performed at 301 of FIG. 3 for a digital workflow generation service. In some embodiments, the digital workflow generation service is implemented by digital workflow service 111 of FIG. 1 and/or digital workflow service 201 of FIG. 2. In some embodiments, the clients used to configure the digital workflow generation service are clients 101, 103, and/or 105 of FIG. 1.

At 401, available components are configured. For example, the components for a particular workflow service configuration are configured. The configured components can correspond to the components that are available for use in the particular workflow service configuration. In some embodiments, the components can include first-party and third-party components. For example, an “update record” component can be a first-party implementation or a third-party implementation that utilizes a third-party service such as a third-party application programming interface (API) to perform the action. In some embodiments, the different components can correspond to different steps of the workflow including actions or functional steps that can read and/or write data including database records as well as flow control steps for managing the execution flow of the workflow. Additional types of steps may be appropriate as well, such as a trigger step. Based on the different configured components made available and accessible for the particular workflow service configuration, different workflows can be created. Workflows that utilize components that are not available will typically be non-functional since the required component cannot be accessed.

At 403, a component prediction model is configured. For example, a component prediction model is configured for the particular workflow service configuration. In various embodiments, the component prediction model is trained using the available components such as the components configured as available at 401. By training the component prediction model using only the subset of components available for the particular workflow service configuration, the model's component predictions are grounded based on actual available components. In various embodiments, this approach to training, by using only the available components or a subset of the available components, minimizes the number and instances of hallucinations. In some embodiments, a different component prediction model can be configured for each workflow service configuration, allowing different workflow service configurations to customize what components are available for their workflows. For example, thousands or more components may be exist (including first-party, third-party, and custom components) but a particular workflow service configuration may be configured to access and potentially use only a smaller set of those existing components. The component prediction model is configured to predict components based only on the configured accessible components.

At 405, a large-language-model is configured. For example, a large-language-model is configured for use to generate a representation of a digital workflow. In various embodiments, the configured large-language-model is trained using a vast amount of data allowing it to learn different patterns and relationships. In some embodiments, the large-language-model is a third-party large-language-model model that is pre-trained by a third-party and is configured for use for the specific workflow service configuration, although a large-language-model may also be trained locally, as appropriate and/or as required. Additionally, fine tuning can be performed for the configured the large-language-model. For example, supervised fine-tuning using output from the component prediction model trained at 403 can be performed. In some embodiments, the output from the trained component prediction model is used as input for the large-language-model along with the corresponding natural language workflow description and an expected generated digital workflow output to train the large-language-model.

In various embodiments, the configured model is set up to receive a generative artificial intelligence (AI) prompt and once the prompt is evaluated by the large-language-model, the output results can be used for creating a digital workflow. In some embodiments, at 405, a prompt template for the large-language-model is configured. The prompt template can include a template structure for including a description or portion of a natural language description of a desired workflow and the corresponding predicted components as provided by the trained component prediction model. In some embodiments, each particular workflow service configuration can be configured with a custom prompt template applicable for the specific workflow service configuration.

At 407, the digital workflow generation service is deployed. For example, once the appropriate components, component prediction model, and large-language-model are configured, the digital workflow generation service can be deployed for use in generating digital workflows. In various embodiments, the trained component prediction model is a customized model for a particular client or customer and is based on the components accessible and configured. For example, two different user accounts may be configured with different sets of components based on their particular usage (and access) requirements. The two different user accounts can each utilize a different component model that is trained based on their particular set of configured components. In some embodiments, the deployed digital workflow generation service is accessible only to particular users or user accounts based on access privileges.

FIG. 5 is a flow chart illustrating an embodiment of a process for configuring a component prediction model. For example, using the process of FIG. 5, a component prediction model can be configured for a specific digital workflow service configuration, such as a configuration for a specific user account, client, customer, etc. As part of the configuration process, the component prediction model can be trained with the set of specific components that are available for use with a specific digital workflow service configuration. By grounding the component prediction model using the components configured for a specific digital workflow service configuration, the trained component prediction model will focus its predictions on components that are available and thereby minimize hallucinations. Once configured, the component prediction model can be utilized for retrieval-augmented workflow generation. For example, in response to a desired workflow description, the trained component prediction model can select components likely to be used for the workflow. In some embodiments, the trained component prediction model is a neural retriever that aligns natural language with a structured representation of components. Using the predicted components along with the desired workflow description, a digital workflow can be generated by a digital workflow generation service. In some embodiments, the process of FIG. 5 is performed at 301 of FIG. 3 and/or at 401 of FIG. 4. In some embodiments, the process of FIG. 5 is implemented by a digital workflow service such as digital workflow service 111 of FIG. 1 and/or digital workflow service 201 of FIG. 2.

At 501, a positive training data set is created. For example, the model can be trained to predict components from natural language workflow descriptions using at least positive training data pairs. In various embodiments, the training data is processed to prepare multiple positive pairs of a query with a corresponding component. The query is a model query that includes the natural language description of the desired workflow, and the corresponding component is one of the components of the corresponding digital workflow, such as a step or table name of the desired workflow. For example, a digital workflow with four components can be used to create four positive training pairs, each using the same query but a different component of the workflow. At 501, a positive training data set is created and prepared for use in training the component prediction model. The workflows used to prepare the training data can be limited to workflows that align with the specific digital workflow service configuration. For example, the positive training pairs only utilize components that are available in the specific digital workflow service configuration.

At 503, a negative training data set is created. For example, the model can be trained to predict components from natural language workflow descriptions using both the positive training set created at 501 and the negative training data pairs created at 503. In various embodiments, the negative training pairs are created by sampling components that are not relevant to a particular query. Different negative sampling techniques can be utilized, such as random sampling, BM25-based sampling, and ANCE-based sampling, among others. The use of negative training pairs trains the model to differentiate between helpful and not helpful components. In various embodiments, the components used for the negative training data can be limited to the components available in the specific digital workflow service configuration. In some embodiments, the components used for the negative training data can include components not available in the specific digital workflow service configuration.

At 505, a data set of common components is identified. For example, the components that are most commonly used in workflows for the specific digital workflow service configuration are identified. These identified components are likely to be present in nearly all workflows. In some embodiments, the common components are identified based on historical data from the set of existing components. In various embodiments, the threshold number of components is determined for the data set of common components. For example, the top 25 components (or another threshold number of components) may be selected for the data set of common components. In some embodiments, the threshold is determined by evaluating the frequency the different components appear in workflows and identifying significant drop offs in frequency of use. For example, the top 25 components may appear in nearly every workflow and starting around the 26th most frequent component, the number of appearances may drop significantly.

At 507, the component prediction model is trained. For example, the model is trained to predict components from natural language workflow descriptions using the data sets created and identified at 501, 503, and/or 505. The model can be trained by excluding the most common components as identified at 505 from the training data. For example, the set of training components can comprise the components from the data sets of 501 and/or 503 that are not in the set of common components from the data set of 505. The modified training data, including the modified positive and negative training data pairs, can be used to train the component prediction model. In some embodiments, the model is a neural retriever and is trained using a technique such as contrastive loss to minimize the distance between positive pairs and negative pairs. In various embodiments, the model is trained to encode both the user query and the component into fixed-length vectors.

In some embodiments, the components including components corresponding to positive and/or negative training pairs can be selected by determining which components are difficult to predict. For example, the process of FIG. 5 can be repeated multiple times to iteratively train the component prediction model and/or to fine tune the component prediction model. In some embodiments, on subsequent rounds of training, the training data components, such as the components for the negative (and/or positive) training pairs, can be selected by evaluating the as-currently trained model for the components that are difficult for the model to predict. For example, components that are hard to predict are used to create a second or subsequent set of training data. The more difficult training pairs are then used to fine tune the component prediction model to improve prediction results.

At 509, the trained component prediction model is associated with a digital workflow service configuration. For example, once trained, the trained component prediction model is associated with a specific digital workflow service configuration and, accordingly, the set of components available or accessible for use as defined by the specific digital workflow service configuration. In some embodiments, the trained model is associated with a user account, user, customer, or another identifier similarly associated with the specific digital workflow service configuration.

FIG. 6 is a flow chart illustrating an embodiment of a process for automatically generating, using a retrieval-augmented technique, a digital workflow from a received workflow description. For example, using the process of FIG. 6, a digital workflow service platform can generate a digital workflow from a natural language description. The digital workflow is generated by initially selecting, based on a description of a desired computer workflow, a set of prospective components to augment a large-language-model. The selection can be performed by providing the desired workflow description to a trained component prediction model. A generative artificial intelligence (AI) prompt using the description of the desired computer workflow and selected set of prospective components is then provided to the large-language-model to generate a representation of the digital workflow. The representation can be a structured representation of such as a text-based representation using JavaScript Object Notation (JSON) or another appropriate format. In some embodiments, the process of FIG. 6 is performed at 303, 305, and/or 307 of FIG. 3. In some embodiments, the digital workflow service platform used to perform the process of FIG. 6 corresponds to digital workflow service 111 of FIG. 1 and/or digital workflow service 201 of FIG. 2.

At 601, workflow components are predicted. For example, prospective components that are likely to be used to implement the desired workflow are selected. In various embodiments, the components are selected by determining that each prospective component satisfies a relevance condition with respect to the desired computer workflow. For example, each selected component should likely be required to implement the desired computer workflow. In various embodiments, the components are selected by using a component prediction model. For example, a query that includes the desired workflow description is used to predict the expected workflow components required to implement the desired workflow. In various embodiments, the component prediction model is selected based on the particular workflow service configuration such that the selected model predicts only components available and/or accessible to the particular workflow service configuration. In some embodiments, the workflow components predicted at 601 exclude the high-frequency components that are common in nearly all workflows. By excluding the high frequency components, the accuracy of the generated workflow is significantly improved.

At 603, a prompt is generated using the predicted components and the workflow description. For example, using a generative artificial intelligence (AI) prompt template, a generative AI prompt is created. The generative AI prompt can include the desired workflow description (or a portion of the description) and the workflow components predicted at 601. In some embodiments, the workflow components are included as structured data in the generative AI prompt using a format such as in a JavaScript Object Notation (JSON) or another appropriate format. By including the predicted components in a structured format in the generative AI prompt, the structure of the provided components are aligned with the desired output, a structured representation of the digital workflow.

At 605, the prompt is evaluated using a large-language-model. For example, the generative AI prompt created at 603 is evaluated at 605 using a large-language-model. The inference results from evaluation are a structure representation of the desired workflow as requested by the generative AI prompt. For example, the structure representation can describe the different steps of the desired workflow with each node of the workflow representation corresponding to a different step or table information. In various embodiments, node attributes can include modifiers for a step such as data parameters or arguments. In various embodiments, the large-language-model output results are a code or coded representation of the digital workflow that can be converted into an executable format. For example, the code representation can be converted into programming or source code and/or used by a workflow engine (that accepts the structured representation) to execute the digital workflow. In some embodiments, the code representation can be used to visualize the workflow using a graphical user interface.

At 607, a generated digital workflow is provided. For example, the generated digital workflow is provided for use as a digital workflow as part of a digital workflow service. Generated using a structured format, the digital workflow can be easily stored, for example, as a database entry and used in workflow services. In various embodiments, the provided digital workflow is used to implement an executable version of the workflow and/or to provide a visual representation of the workflow, such as via a workflow graphical user interface (GUI) designer tool. For example, using a workflow GUI designer tool, the provided workflow can be further modified to customize the workflow with data parameters or arguments.

FIG. 7 is a diagram illustrating an embodiment of a user interface for creating a digital workflow from a natural language description. In the example shown, user interface 700 is a user interface dialog of a digital workflow service. User interface 700 includes desired workflow name dialog 703 and desired workflow description dialog 705. In various embodiments, a user provides a name and a natural language description of a desired workflow via desired workflow name dialog 703 and desired workflow description dialog 705, respectively. In response, the digital workflow service automatically generates a digital workflow using the techniques disclosed herein. In the example shown, the desired workflow name is “Daily Triage” and the natural language description of the desired workflow is provided as “Create a flow that runs every day at midnight, and then find all the newly created problem records for the past day. If they are not assigned, assign the problem to level 1 triage group.” To create the digital workflow from the provided natural language description using the processes of FIGS. 3-6, the user selects the user interface button labeled “Build with Now Assist.” In some embodiments, user interface 700 is utilized at 303 of FIG. 3 to obtain the desired workflow description. In some embodiments, the digital workflow service used to implement user interface 700 is digital workflow service 111 of FIG. 1 and/or digital workflow service 201 of FIG. 2. In some embodiments, user interface 700 is implemented using a workflow user interface module of a digital workflow service such as workflow user interface module 221 of FIG. 2. In some embodiments, the clients used to interface with user interface 700 are clients 101, 103, and/or 105 of FIG. 1.

FIG. 8 is a diagram illustrating an embodiment of a digital workflow generated from a natural language description. In the example shown, digital workflow 800 is generated from a natural language description of a desired workflow. In some embodiments, the description is the description shown in desired workflow description dialog 705 of FIG. 7. As shown in FIG. 8, digital workflow 800 is a structured representation of a digital workflow and includes multiple components. In the example shown, digital workflow 800 is initiated by a “trigger” component and once initiated, the generated workflow includes four different step components to implement the desired workflow. For example, the generated workflow utilizes the components: “look_up_records,” “FOREACH,” “IF,” and “update_record.” In some embodiments, digital workflow 800 can be converted into a visual representation of the workflow and data parameters and/or arguments of the workflow can be added or modified. In some embodiments, digital workflow 800 can be used to automatically code the desired workflow for execution by a digital workflow service. In some embodiments, digital workflow 800 is the workflow generated and provided by a digital workflow service at 307 of FIG. 3 and/or at 607 of FIG. 6. In some embodiments, the digital workflow service used to generate digital workflow 800 is digital workflow service 111 of FIG. 1 and/or digital workflow service 201 of FIG. 2.

FIG. 9 is a diagram illustrating an embodiment of a training data example used to train a large-language-model to generate a digital workflow from a natural language description. In the example shown, training data example 900 includes a predicted components section, a desired workflow description section, and the expected output section. In various embodiments, the predicted components section is prefaced with a <|system|>tag and is the structured output from a component prediction model. The desired workflow description section is prefaced with a <|user|>tag and corresponds to the natural language description of the desired workflow in a user query format. In various embodiments, the natural language description is used to predict the components of the predicted components section. The last five lines of training data example 900 correspond to the expected output section and is the expected generated digital workflow for the desired workflow description. In various embodiments, training data example 900 is an example of training data used to perform supervised fine-tuning of the large-language-model used to generate digital workflows. In the example shown, common components are excluded from the training data. In various embodiments, a generative artificial intelligence (AI) prompt used to generate a digital workflow corresponds to training data example 900 but without the expected output section. For example, a generative AI prompt for a new desired workflow (now shown) will include a predicted components section and a desired workflow description section. In some embodiments, training data such as training data example 900 is utilized at 301 of FIG. 3 and/or at 405 of FIG. 4 to configure a large-language-model to generate a digital workflow. In some embodiments, training data such as training data example 900 is utilized as part of the digital workflow generation process performed at 305 of FIG. 3 and/or the prompt evaluation process performed at 605 of FIG. 6. In some embodiments, the digital workflow service used to generate and train with training data such as training data example 900 is digital workflow service 111 of FIG. 1 and/or digital workflow service 201 of FIG. 2.

FIG. 10 is a functional diagram illustrating a programmed computer system for creating a digital workflow from a natural language description. As will be apparent, other computer system architectures and configurations can be utilized for creating a digital workflow from a natural language description including those with one or more graphical processing units (GPUs). Examples of computer system 1000 include clients 101, 103, and 105 of FIG. 1, one or more computers of digital workflow service 111 of FIG. 1, and/or one or more computers of digital workflow service 201 of FIG. 2. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018). In various embodiments, one or more instances of computer system 1000 can be used to implement at least portions of the processes of FIGS. 3-6 and/or the user interface of FIG. 7, and to generate digital workflow 800 of FIG. 800 and/or training data example 900 of FIG. 9.

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data and objects used by the processor 1002 to perform its functions (e.g., programmed instructions). For example, memory 1010 can include any suitable computer-readable storage media, described below, depending on whether, for example, data access needs to be bi-directional or unidirectional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or unidirectionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storages 1012, 1020 generally store additional programming instructions, data, and the like that typically are not in active use by the processor 1002. It will be appreciated that the information retained within mass storages 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

One aspect of the disclosure includes a method for obtaining a description of a desired computer workflow. Based on the description of the desired computer workflow, a set of prospective components from a plurality of components is selected. A prompt is generated using the description of the desired computer workflow and the set of prospective components. Based on providing the prompt to a large-language-model, at least a portion of code associated with the desired computer workflow is generated. Implementations of the disclosure may include one or more of the following optional features including using a result of the large-language-model to automatically code the desired computer workflow; wherein the generated code associated with the desired computer workflow is a structured representation defining the desired computer workflow; wherein selecting, based on the description of the desired computer workflow, the set of prospective components from the plurality of components includes determining that each prospective component of the set of prospective components satisfies a relevance condition with respect to the desired computer workflow; wherein selecting, based on the description of the desired computer workflow, the set of prospective components from the plurality of components includes using a component prediction model; wherein the description of the desired computer workflow corresponds to a natural language description; wherein the description of the desired computer workflow includes an unstructured description; and wherein generating the prompt using the description of the desired computer workflow and the set of prospective components includes utilizing a structured format for the set of prospective components.

Further implementations of the disclosure may include one or more of the following optional features including selecting the component prediction model from a plurality of component prediction models based on a workflow service configuration; and wherein the workflow service configuration is associated with a set of available components accessible to a user account. Additional implementations of the disclosure may include one or more of the following optional features including wherein selecting, based on the description of the desired computer workflow, the set of prospective components from the plurality of components includes: identifying, based on historical data, a set of common components from a plurality of existing components; selecting a set of training components, the set of training components comprising each respective component of the plurality of existing components that is not in the set of common components; and training, using the set of training components, the component prediction model.

Another aspect of the disclosure provides a system with one or more processors and a memory coupled to the one or more processors. The memory is configured to provide the one or more processors with instructions. When executed, the instructions cause the one or more processors to obtain a description of a desired computer workflow; select, based on the description of the desired computer workflow, a set of prospective components from a plurality of components; generate a prompt using the description of the desired computer workflow and the set of prospective components; and generate, based on providing the prompt to a large-language-model, at least a portion of code associated with the desired computer workflow. This aspect may include one or more of the following optional features including wherein the memory is further configured to provide the one or more processors with instructions which when executed cause the one or more processors to use a result of the large-language-model to automatically code the desired computer workflow; wherein the generated code associated with the desired computer workflow is a structured representation defining the desired computer workflow; wherein selecting, based on the description of the desired computer workflow, the set of prospective components from the plurality of components includes determining that each prospective component of the set of prospective components satisfies a relevance condition with respect to the desired computer workflow; wherein selecting, based on the description of the desired computer workflow, the set of prospective components from the plurality of components includes using a component prediction model; wherein the description of the desired computer workflow corresponds to a natural language description; and wherein generating the prompt using the description of the desired computer workflow and the set of prospective components includes utilizing a structured format for the set of prospective components. Additionally, this aspect may include one or more of the following optional features wherein selecting, based on the description of the desired computer workflow, the set of prospective components from the plurality of components includes: identifying, based on historical data, a set of common components from a plurality of existing components; selecting a set of training components, the set of training components comprising each respective component of the plurality of existing components that is not in the set of common components; and training, using the set of training components, the component prediction model. The details of one or more implementations of the disclosure are set forth in the accompanying drawings and description. Other aspects, features, and advantages will be apparent from the description and drawings, and from the claims.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
obtaining a description of a desired computer workflow;
selecting, based on the description of the desired computer workflow, a set of prospective components from a plurality of components;
generating a prompt using the description of the desired computer workflow and the set of prospective components; and
generating, based on providing the prompt to a large-language-model, at least a portion of code associated with the desired computer workflow.

2. The method of claim 1, further comprising using a result of the large-language-model to automatically code the desired computer workflow.

3. The method of claim 1, wherein the generated code associated with the desired computer workflow is a structured representation defining the desired computer workflow.

4. The method of claim 1, wherein selecting, based on the description of the desired computer workflow, the set of prospective components from the plurality of components includes determining that each prospective component of the set of prospective components satisfies a relevance condition with respect to the desired computer workflow.

5. The method of claim 1, wherein selecting, based on the description of the desired computer workflow, the set of prospective components from the plurality of components includes using a component prediction model.

6. The method of claim 5, further comprising selecting the component prediction model from a plurality of component prediction models based on a workflow service configuration.

7. The method of claim 6, wherein the workflow service configuration is associated with a set of available components accessible to a user account.

8. The method of claim 5, wherein selecting, based on the description of the desired computer workflow, the set of prospective components from the plurality of components includes:
identifying, based on historical data, a set of common components from a plurality of existing components;
selecting a set of training components, the set of training components comprising each respective component of the plurality of existing components that is not in the set of common components; and
training, using the set of training components, the component prediction model.

9. The method of claim 1, wherein the description of the desired computer workflow corresponds to a natural language description.

10. The method of claim 1, wherein the description of the desired computer workflow includes an unstructured description.

11. The method of claim 1, wherein generating the prompt using the description of the desired computer workflow and the set of prospective components includes utilizing a structured format for the set of prospective components.

12. A system, comprising:
one or more processors; and
a memory coupled to the one or more processors, wherein the memory is configured to provide the one or more processors with instructions which when executed cause the one or more processors to:
obtain a description of a desired computer workflow;
select, based on the description of the desired computer workflow, a set of prospective components from a plurality of components;
generate a prompt using the description of the desired computer workflow and the set of prospective components; and
generate, based on providing the prompt to a large-language-model, at least a portion of code associated with the desired computer workflow.

13. The system of claim 12, wherein the memory is further configured to provide the one or more processors with instructions which when executed cause the one or more processors to use a result of the large-language-model to automatically code the desired computer workflow.

14. The system of claim 12, wherein the generated code associated with the desired computer workflow is a structured representation defining the desired computer workflow.

15. The system of claim 12, wherein selecting, based on the description of the desired computer workflow, the set of prospective components from the plurality of components includes determining that each prospective component of the set of prospective components satisfies a relevance condition with respect to the desired computer workflow.

16. The system of claim 12, wherein selecting, based on the description of the desired computer workflow, the set of prospective components from the plurality of components includes using a component prediction model.

17. The system of claim 16, wherein selecting, based on the description of the desired computer workflow, the set of prospective components from the plurality of components includes:
identifying, based on historical data, a set of common components from a plurality of existing components;
selecting a set of training components, the set of training components comprising each respective component of the plurality of existing components that is not in the set of common components; and
training, using the set of training components, the component prediction model.

18. The system of claim 12, wherein the description of the desired computer workflow corresponds to a natural language description.

19. The system of claim 12, wherein generating the prompt using the description of the desired computer workflow and the set of prospective components includes utilizing a structured format for the set of prospective components.

20. A computer program product, the computer program product being embodied in a non-transitory computer readable storage medium and comprising computer instructions for:
obtaining a description of a desired computer workflow;
selecting, based on the description of the desired computer workflow, a set of prospective components from a plurality of components;
generating a prompt using the description of the desired computer workflow and the set of prospective components; and
generating, based on providing the prompt to a large-language-model, at least a portion of code associated with the desired computer workflow.
